(19) United States
(12) Patent Application Publication
(10) Pub. No.: US 2004/0118322 A1
(43) Pub. Date: Jun. 24, 2004

(54) Airport concrete pavement with the preset strength safety level

(76) Inventor: Naum Sapozhnikov, Los Angeles, CA (US)

Correspondence Address: Naum Sapozhnikov, 1550 N. Poinsettia Pl., Apt. 210, Los Angeles, CA, 90046, US

(21) Appl. No.: 10/696,085

(22) Filed: Oct. 29, 2003

Related U.S. Application Data
(60) Provisional application No. 60/422,533, filed on Oct. 31, 2002.

(51) Int. Cl. C04B 7/00; C04B 9/12; C04B 28/00; C04B 28/04

(52) U.S. Cl. 106/713

(57) ABSTRACT

Airport concrete pavement for aprons, taxiways, hard standings, runway ends for distance of 1,000 ft., and hangar floors as critical areas and concrete pavement for runways (central portion) and some high-speed exit taxiways as noncritical areas of airport are designed with the preset strength safety levels corresponding to strength safety indexes β equal at least to about 3 and 2.5, respectively. Thickness of these pavements is less by 8-10% and 5-10% for critical and noncritical areas of airport, respectively, than that provided by thickness design according to Portland Cement Association Engineering Bulletin (Design of Concrete Airport Pavement, Portland Cement Association, EB 050P). It is achieved due to more complete utilization of flexural strength of concrete than that provided by the current Portland Cement Association design practice. More complete utilization of flexural strength of concrete considered as a random value means the use of values of modulus of rupture exceeding the mean value of flexural strength for thickness design of pavement. Mix design of concrete of each claimed pavement is determined by the value of modulus of rupture (MR) required by the thickness design of this pavement according to said Portland Cement Association Engineering Bulletin. More complete utilization of flexural strength of concrete is based on the statistical investigation of flexural strength of concrete in connection with the compressive strength of this concrete. This investigation was carried out by the processing data of American test results of concrete strength.

According to the invention, fatigue analysis of pavement should be carried out according to the most detailed version of the current Portland Cement Association design procedure or with the use of other methods of fatigue analysis according to the requirements of the customer with more complete utilization of flexural strength of concrete by consecutive use of three values of 90-day modulus of rupture (MR) with the difference of 50 psi. These three values of 90-day modulus of rupture are considered as corresponding to one value of 28-day specified compressive strength of this concrete f_{c}′. The least of these three is the value of modulus of rupture (MR) required by thickness design of pavement according to said Portland Cement Association Engineering Bulletin. Any of these three values of modulus of rupture of concrete (MR) can be used for fatigue analysis of pavement, if strength safety of pavement designed with the use of this value of specified flexural strength corresponds at least to strength safety level required according to the invention. More exact estimation of fatigue strength of pavement provides reduction of thickness of pavement.

Moreover, revaluation of strength safety and fatigue strength of existing airport pavements for increasing of allowable aircraft loads is possible due to more complete utilization of flexural strength of concrete than that provided by the current Portland Cement Association design practice of utilization of this strength.

The essence of present invention is in the more complete utilization of flexural strength of concrete than that provided by the current design practice. It is applied to the thickness design of airport critical and noncritical areas pavement with fatigue analysis according to said Portland Cement Association Engineering Bulletin, and can be applied to the thickness design of this pavement with other methods of fatigue analysis.

Furthermore, consideration of statistical connections between flexural and compressive concrete strength allows to choose value of 90-days modulus of rupture (MR) in connection with the corresponding value of 28-days specified compressive strength of this concrete f_{c}′. It allows to provide design concrete composition for claimed pavement by means of corresponding value of specified compressive strength of this concrete f_{c}′.

### REFERENCE TO RELATED APPLICATION

Provisional Patent Application No. 60/422,533 Filing Data Oct. 31, 2002

### FEDERALLY SPONSORED RESEARCH

Not Applicable

### SEQUENCE LISTING PROGRAM

Not Applicable

### BACKGROUND

1. Field of Invention

This invention relates to the field of design and construction of highway and street concrete pavements.

2. Description of Prior Art

Airport concrete pavements in the US building practice are designed usually according to Portland Cement Association Engineering Bulletin (Design of Concrete Airport Pavement, Portland Cement Association, EB 050P). Strength safety of these pavements is provided by this design indirectly by limitation of working stresses. Working stress of airport pavement is determined by the dividing the value of modulus of rupture of concrete (MR) by the safety factor chosen. Safety factor is in the range from 1.7 to 2.0 for aprons, taxiways, hard standings, runway ends for distance of 1,000 ft., and hangar floors as critical areas of airport. Safety factor is in the range from 1.4 to 1.7 for runways (central portions) and some high-speed exit taxiways as noncritical areas of airport. There are very wide ranges of values of safety factor and corresponding estimations of strength safety of pavement.

Estimations of strength safety of structural members are expressed usually by strength safety index β. Values of strength safety index β equal to 2, 2.5 and 3 are corresponded to estimations of strength safety equal to 0.9772, 0.9938 and 0.9986, respectively. Estimation of strength safety of structural member corresponding to value of strength safety index β equal at least to 3 is considered usually as close to unity in the engineering applications of such types. Estimations of strength safety as a function of the strength safety index β are determined by the Table of normal distribution of density of probability presented in all reliability handbooks (Grant E. L. Statistical Quality Control, 3d ed., 1964, Mc Graw-Hill, for example).

The preset strength safety level of airport concrete pavements should be chosen on the basis of analysis of the existing strength safety level of real structural members, since the practice is the only criterion of strength safety. The few considerable samplings of test results of underreinforced prestressed floor and roof slabs of multi-story building frames, mainly prestressed hollow-core slabs, can be used for the estimation of existing strength safety level of real structures. These slabs were designed according to the Russian building code, produced and tested at the Russian plants of precast concrete; Russian construction is based on the use of precast concrete, and the Russian building code requires regular tests of these structural members, mainly floor and roof slabs. Furthermore, the estimation of strength safety of these slabs was compared with the estimation of strength safety of columns, which is based on the test results of 111 axially loaded reinforced concrete columns of multi-story building frames produced on the Moscow plants (Sapozhnikov N. Strength Safety of Precast Reinforced Concrete and Prestressed Structural Members. State Committee of Construction of the USSR Institute of Information, Moscow, 1989, Tables 12 and 24).

Estimations of the strength safety level of these members as probabilities P(M_{fail}^{test}>M_{des}^{SNiP}) are presented in form of strength safety index β, with the value of M_{des}^{SNiP} considered the design moment strength of member, i.e. factored moment according to current Russian code. Estimations of the strength safety of these slabs correspond to the values of strength safety indexes β in the range of 2.15 to 3 for samplings of test results of slabs of one type but with different spans produced at different plants. Estimations of the strength safety of these slabs produced at one plant correspond to values of strength safety indexes β in the range from 2.5 to 3, and the strength safety level of these slabs is no less than that of reinforced columns of these multi-story building frames. These estimations of strength safety can be applied to the American building practice by comparison of strength design of underreinforced slabs floor and roof according to American and Russian building codes.

To apply this data to the American building practice it is necessary to compare the strength design of the same underreinforced flexural members according to the American building code ACI 318 and the Russian building code. Service loads in American building codes are higher than those in Russian building codes, but due to the Russian design practice of unification of loads on the floor slabs and the use of floor slabs as roof slabs, this difference is practically negligible. The load factors in strength design are significantly higher in American building codes than those in Russian building codes (1.4 and 1.1 for dead loads, 1.7 and 1.2-1.3 for live loads in the American and Russian building codes, respectively). As a result, the factor loads for floor slabs designed according to the American building code ACI 318 are higher at least by 28.5% than that for slabs with the same dimensions under the same service loads designed according to the Russian current building code. For underreinforced flexural members, the increase of the factor moment means the corresponding increase of consumption of tension reinforcement.

The capacity of underreinforced floor and roof slabs is determined almost completely by the strength of tension reinforcement. The strength safety of these members is estimated in the form of probability P(M_{capacity}>M_{des}), where M_{capacity} is the capacity of flexural member as a moment strength considered as a random value and M_{des} is the design strength of this member defined as a factored moment strength (required moment strength of member) determined according to the current building code. This probability presented in the form P(M_{capacity}/M_{des}>1) is more suitable for the estimation of the strength safety of flexural members. The mean value of the ratio M_{capacity}/M_{des} is an important and suitable index of strength safety of these structural members.

The consumption of tension reinforcement in an underreinforced flexural member is determined by the value of the required moment strength. The increase of this strength requires a proportional increase in the consumption of tension reinforcement of member and a corresponding increase of the mean value of capacity of this flexural member M_{capacity}. As a result, the mean value of the ratio M_{capacity}/M_{des} of an underreinforced flexural member varies only slightly with the change of consumption of tension reinforcement. As applied to floor and roof slabs, the ratio M_{capacity}/M_{des} is practically constant for slabs with similar dimensions but with different consumption of tension reinforcement until these slabs can be considered as underreinforced members with a small influence of concrete strength on the flexural strength of member.

Estimations of the strength safety of similar floor and roof slabs designed according to the American and Russian building codes can be defined as the probabilities P(M_{capacity}^{ACI}/M_{des}^{ACI}>1) and P(M_{capacity}^{SNiP}/M_{des}^{SNiP}>1) respectively. The values of the ratios M_{capacity}^{ACI}/M_{des}^{ACI} and M_{capacity}^{SNiP}/M_{des}^{SNiP} are close, and the estimations of probabilities P(M_{capacity}^{ACI}/M_{des}^{ACI}>1) and P(M_{capacity}^{SNiP}/M_{des}^{SNiP}>1) should be close also. At the same time, the probability P(M_{capacity}^{ACI}>M_{service}) for slabs designed according to ACI 318 is higher significantly than the probability P(M_{capacity}^{SNiP}>M_{service}) for slab designed according to Russian building code. M_{service} is considered as service moment strength the same for slabs designed according to American and Russian building codes.

It is apparent that the real strength safety level of underreinforced slabs designed according to the American current building code ACI 318 is significantly higher than that for the same slabs designed according to the Russian building code. However, the formal estimations of strength safety of these underreinforced slabs designed according to American and Russian building codes are very close. It allows one to use results of strength safety analysis of underreinforced prestressed floor and roof slabs designed according to the Russian building code, produced and tested at the Russian plants for the choice of preset strength safety of concrete pavement of highways and streets.

Estimation of strength safety of concrete pavements requires the use of statistical characteristics of flexural strength of concrete. These statistical characteristics of the concrete strength were investigated in connection with the statistical characteristics of the compressive strength of this concrete, since compressive strength is the natural quality of concrete more commonly used and significantly better understood than flexural strength. This investigation was carried out by the processing of the data of the American test results of compressive and flexural concrete samples, and a small portion of British test results of modified cubes and standard beams (Sapozhnikov N. Safety of Precast Reinforced Concrete and Prestressed Structural Members by the Second Limit State (Serviceability Limit State). State Committee of Construction of the USSR Institute of Information, Moscow, 1991, Table 6).

Two large samplings of test results of compressive and flexural strength of concrete include 3650 series of test results of standard cylinders and beams 1107 series of test results of modified cubes and standard beams. These test results were used for the analysis of statistical connections between the compressive and flexural strength of concrete. These connections can be estimated as statistically significant; coefficients of correlation between the cylinder compressive strength and the flexural strength of concrete, between the modified cube strength and the flexural strength of concrete are equal to 0.831 and 0.864, respectively. These values of the coefficient of correlation allow one to consider the statistical characteristics of flexural strength of concrete stemming from those for the compressive strength of this concrete.

Flexural strength is not an inherent quality of concrete unlike compressive strength, and design estimations of flexural strength are assessed with extreme caution. It can be seen by the example of estimation of safety of permissible flexural stress used for the calculation of the cracking moment of prestressed flexural members according to said American building code ACI 318. Permissible flexural stress for concrete of prestressed members given to control of serviceability is equal to 6√f_{c}′ according to said building code ACI 318 (item 18.4.2 c), where f_{c}′ is the specified compressive strength of concrete. Since the cracking design of prestressed members is related to serviceability limit state, the value of the permissible flexural stress of concrete equal to 6√f_{c}′ can be considered as specified flexural strength of this concrete. The safety of this value of specified flexural strength can be assessed as a probability P(fᵣ>6√f_{c}′), where the flexural strength fᵣ is considered as a random value. As a first step for estimation of the safety of permissible flexural strength of concrete, probability P(fᵣ>6√f_{c}) was calculated with the use of 3650 series of the American test results of standard concrete cylinders and beams. The empirical estimation of this probability is equal to 0.9952, and this value of probability corresponds to strength safety index β equal to 2.59 (Sapozhnikov N. Safety of Precast Reinforced Concrete and Prestressed Structural Members by the Second Limit State (Serviceability Limit State). State Committee of Construction of the USSR Institute of Information, Moscow, 1991, page 47).

According to said American building code ACI 318 (item 5.3.2.1) the required average compressive strength of concrete should exceed the specified compressive strength of this concrete f_{c}′ by at least by 25%, if coefficient of variation of this strength is assumed to be 15%. Considering the experimental value of compressive strength of concrete f_{c} as average, the specified compressive strength of this concrete f_{c}′ can be estimated to be 25% less. Taking into account this difference between f_{c}′ and f_{c}, the probability P(fᵣ>6√f_{c}′) can be estimated conventionally as corresponding to strength safety index β equal to 2.88. It seems useful to compare this estimation of safety of permissible flexural stress considered as a specified flexural strength of concrete with the safety of the specified and the design compressive strength of concrete and the yield strength of tension reinforcement.

According to said American building code ACI 318, the specified compressive strength of concrete f_{c}′ constitutes approximately 0.8 of mean value of this strength, and the safety of specified strength corresponds to strength safety index β equal to 1.34. Design compressive strength of concrete for underreinforced flexural members can be estimated as φf_{c}′, where φ is strength reduction factor equal to 0.9 (ACI 318 building code, item 9.3.2.1). Design compressive strength of concrete for axially loaded columns with tie reinforcement conforming can be estimated as 0.476 of specified compressive strength f_{c}′ (ACI 318 building code, item 10.3.5.2).

The safety of design compressive strength of underreinforced floor and roof slabs corresponds to value of strength safety index β equal to 1.87, whereas the safety of design compressive strength of axially loaded reinforced concrete columns corresponds to value of strength safety index β equal to 4.13, with the coefficient of variation of compressive strength of concrete assumed to be 15%. This difference can be justified by the different requirements of the concrete strength of underreinforced floor and roof slabs and reinforced concrete columns of a multi-story building frame.

The mean value and standard deviation of yield strength of deformed bars Grade 60 ASTM A615 used as tension reinforcement of floor and roof slabs are equal to 67.5 and 6.6 ksi, respectively (MacGregor J. G., Mirza S. A., Ellingwood B., Statistical Analysis of Resistance of Reinforced and Prestressed Concrete Members. American Concrete Institute Journal, Proceedings vol. 80 May-June 1983/No. 3 pp. 167-176, Table 1). The ratio between specified yield strength and main value of yield strength of this reinforcement is equal to 0.888. The safety of specified yield strength of this reinforcement is defined as a probability P(F_{y}>f_{y}), where F_{y} is the yield strength considered as a random value and f_{y} is the specified yield strength equal to 60 ksi. The estimation of this probability corresponds to strength safety index β equal to 1.14.

The design strength of deformed bars ASTM A615 as tension reinforcement of underreinforced floor and roof slabs can be estimated approximately as φf_{y}, where f_{y} is the specified yield strength of reinforcement, φ is the strength reduction factor equal to 0.9 (ACI 318 building code, item 9.3.2.1). The safety of the design yield strength of this reinforcement defined as a probability P(F_{y}>φf_{y}) corresponds to strength safety index β equal to 2.05.

Thus, the strength safety level of permissible flexural stress of concrete used for the estimation of cracking resistance of prestressed members under service loads according to said American building code ACI 318 is very high. It is significantly higher than the safety of the specified and design compressive strength of concrete of flexural underreinforced members and the safety of specified and even design strength of deformed bars Grade 60 ASTM A615 used as tension reinforcement of underreinforced floor and roof slabs. The probability of compressive strength less than specified one is higher by 45 times than that for permissible flexural strength of concrete of prestressed members. Estimation of the strength safety level of permissible flexural stress of concrete is a value of the same order as the safety of compressive strength of axially loaded columns. A very high strength safety level of permissible flexural stress of concrete means the underestimation of flexural strength of concrete as a random value and a low level of the utilization of this strength.

A low level of the utilization of the flexural strength of concrete and high strength safety level of estimations of the design flexural strength of concrete are not related only to the American building practice. The analysis of the safety of the cracking resistance of prestressed flexural members designed according to the current Russian building was provided based on the processing of the data of more than 2,000 test results of these members (Sapozhnikov N. Safety of Precast Reinforced Concrete and Prestressed Structural Members by the Second Limit State (Serviceability Limit State). State Committee of Construction of the USSR Institute of Information, Moscow, 1991, Table 4). The estimation of the safety of the cracking resistance of prestressed flexural members under service loads can be defined as a probability P(M_{cr}^{test}>M_{service}) or P(M_{cr}^{test}/M_{service}), where M_{service} is the moment service force. The estimations of the safety of cracking resistance are significantly higher for samplings of test results of prestressed hollow-core and flat slabs with a developed tension zone than those for prestressed ribbed slabs and roof beams with an insignificant tension zone. The availability of the developed tension zone of prestressed members with the underestimated resources of flexural strength means the increase of the safety of cracking resistance which does not taking into account by building code.

Thus, the flexural and tension strengths of concrete are underestimated in the world building practice. A statistical investigation of these types of concrete strength in connection with the compressive strength of this concrete was carried out by the processing of the data of American test results of concrete strength. The results of this investigation can be useful for more complete utilization of flexural strength of concrete in connection with the compressive strength of this concrete as applied to thickness design of airport concrete pavements.

### OBJECTS AND ADVANTAGES

The main object of the present invention is the airport concrete pavement for aprons, taxiways, hard standings, runway ends for distance of 1,000 ft and hangar floors as critical areas of airport designed with the preset strength safety level of this pavement corresponds to strength safety index β equal at least to about 3, with the thickness less by 8-10% than that for this pavement designed according to said Portland Cement Association Engineering Bulletin (Design of Concrete Airport Pavement, Portland Cement Association, EB 050P), reduction of thickness should be achieved due to more complete utilization of flexural strength of concrete considered as random value than that provided by the current Portland Cement Association design procedure, mix design of concrete is carried out depending on the value of modulus of rupture (MR) required by the thickness design of pavement according to said Portland Cement Association Engineering Bulletin.

Another object of the present invention is the airport concrete pavement for runways (central portion) and some high-speed exit taxiways as noncritical areas of airport of airport designed with the preset strength safety level of this pavement corresponds to strength safety index β equal at least to about 2.5, with the thickness less by 5-10% than that for this pavement designed according to said Portland Cement Association Engineering Bulletin, reduction of thickness should be achieved due to more complete utilization of flexural strength of concrete considered as random value than that provided by the current Portland Cement Association design procedure, mix design of concrete is carried out depending on the value of modulus of rupture (MR) required by the thickness design of pavement according to said Portland Cement Association Engineering Bulletin.

Still another important object of present invention is the possibility of revaluation of strength safety and fatigue strength of existing airport pavement due to more complete utilization of flexural strength of concrete than that provided by the current Portland Cement Association design practice of utilization of this strength for increasing of allowable aircraft loads.

One more important object of present invention is the choice of the value of 90-day modulus of rupture (MR) required by the thickness design of claimed pavement according to said Portland Cement Association Engineering Bulletin in connection with the corresponding value of 28-day specified compressive strength of this concrete f_{c}′ due to taking into account the statistical connections between flexural and compressive concrete strength, and mix design of concrete, which should be determined by this value of modulus of rupture(MR), by means of value of specified compressive strength f_{c}′ corresponding to this value of modulus of rupture (MR).

The main advantage of present invention is the actual saving of 8-10% and 5-10% of total consumption of concrete for pavements of airport critical and noncritical areas, respectively, due to more complete utilization of flexural strength considered as a random value than that provided by the current Portland Cement Association design procedure.

Another important advantage of present invention is the possibility of increasing of allowable aircraft loads of existing airport pavement due to more complete utilization of flexural strength considered as a random value than that provided by the current Portland Cement Association design procedure.

Still another important advantage of present invention is the possibility of design of concrete composition for 90-day flexural strength of pavement by means of the value of 28-days specified compressive strength of this concrete f_{c}′ taking into account close statistical connections between compressive and flexural strength. Compressive strength of concrete is the common applied and well-studied characteristic of concrete, and mix design of concrete of the certain value of specified compressive strength f_{c}′ is more conventional procedure than that for modulus of rupture (MR).

These and other objects and advantages are attained in the invention, the essence of which consists in taking into account all possibilities for utilization of flexural strength of concrete as completely as possible, considering this strength as a random value in connection with the compressive strength of this concrete.

### SUMMARY

Airport concrete pavement for aprons, taxiways, hard standings, runway ends for distance of 1,000 ft., and hangar floors as critical areas of airport designed with the preset strength safety level corresponding to value of strength safety index β equal at least to about 3. Thickness of claimed pavement is by 8-10% less than that provided by the thickness design of this pavement according to said Portland Cement Association Engineering Bulletin (Design of Concrete Airport Pavement, Portland Cement Association, EB 050P). It is achieved due to more complete utilization of flexural strength of concrete considered as a random value as compared with the utilization of flexural strength of concrete provided by the current Portland Cement Association design procedure.

Thickness of claimed pavement is determined by requirements for fatigue strength. Fatigue analysis of claimed pavement should be carried out with more complete utilization of flexural strength of concrete than that provided by the current Portland Cement Association design procedure. More complete utilization of flexural strength of concrete considered as a random value means the use of the values of modulus of rupture (MR) exceeding the mean value of flexural strength.

According to the invention, more complete utilization of flexural strength of concrete considered as a random value for fatigue analysis of pavement should be provided by the consecutive use of three values of 90-day modulus of rupture of concrete (MR) with the difference of 50 psi. These three values of 90-day modulus of rupture are considered as the values of specified flexural strength of concrete and representatives of distribution of density of probability of flexural strength of this concrete corresponding to the one value of 28-day specified compressive strength f_{c}′ of this concrete. The least of these three values of modulus of rupture of concrete is the value of modulus of rupture (MR) required by thickness design of this pavement according to said Portland Cement Association Engineering Bulletin. Any of these three value of modulus of rupture of concrete (MR) can be used for fatigue analysis of claimed pavement, if estimation of strength safety of this pavement designed with the use of the certain value of safety factor and this value of modulus of rupture is not less than preset strength safety level of claimed pavement. Thickness design of claimed pavements of airport critical areas should begin by the estimation of values of thickness of pavement corresponding to all values of safety factor in the range from 1.7 to 2.0 according to said Portland Cement Association Engineering Bulletin regardless of fatigue effect. Sufficiency of pavement of these values of thickness in terms of fatigue strength should be checked by results of fatigue analysis of pavement.

According to said Engineering Bulletin, fatigue effect basing on general knowledge of number of load applications expected during the pavement's life is reflected in the thickness design of pavement by the choice of more conservative value of safety factor. According to the invention, sufficiency of pavement of values of thickness corresponding to values of safety factor in the range from 1.7 to 2.0 in terms of fatigue strength should be checked by results of fatigue analysis of pavement. Fatigue analysis of pavement should be carried out according to the most detailed version of the current Portland Cement Association design procedure or with the use of other methods of fatigue analysis according to the requirements of the customer with more complete utilization of flexural strength of concrete than that provided by the current Portland Cement Association design practice of utilization of this strength. It also relates to thickness design of pavement with determined specific forecast of traffic loads and volumes expected during the pavement's life.

Fatigue analysis is carried out beginning with the most conservative values of safety factor, if estimation of fatigue effect is based on general knowledge of number of load applications expected during the pavement's life. If specific forecast of traffic loads and volumes have been determined, design procedure should begin from the least value of safety factor in this range. Minimum value of thickness of pavement of airport critical areas designed with the use of the value of safety factor in the range from 1.7 to 2.0 with the results of fatigue analysis corresponding to requirements of fatigue analysis is considered as acceptable.

Airport concrete pavement for runways (central portion) and some high-speed exit taxiways as noncritical areas of airport designed with the preset strength safety level corresponding to value of strength safety index β equal at least to about 2.5 has thickness by 5-10% less than that provided by thickness design of this pavement according to said Portland Cement Association Engineering Bulletin (Design of Concrete Airport Pavement, Portland Cement Association, EB 050P). It is achieved due to more complete utilization of flexural strength of concrete considered as a random value for fatigue analysis of pavement than that provided by the Portland Cement Association design practice of utilization of this strength.

According to said Portland Cement Association Engineering Bulletin values of the safety factor for thickness design of pavement of noncritical areas of airport are in the range from 1.4 to 1.7. Estimation of strength safety of pavement with the thickness corresponding to value of safety factor equal to 1.4 is less than preset strength safety level of pavement of noncritical areas, and this value o safety factor can not be used for thickness design of claimed pavement.

Thickness design procedure of pavement of noncritical airport areas is the same as for pavement of critical areas. It should be provided with the values of safety factor in the range from 1.5 to 1.7 and required strength safety level correspond to values of strength safety index β equal at least to 2.5. Fatigue analysis of pavement with more complete utilization of flexural strength of concrete than that provided by the current Portland Cement Association design procedure should be carried out according to the most detailed version of the current Portland Cement Association design procedure or with the use of other methods of fatigue analysis according to the requirements of the customer.

Moreover, revaluation of strength safety and fatigue strength of existing airport pavements for increasing of allowable aircraft loads is possible due to more complete utilization of flexural strength of concrete than that provided by the current Portland Cement Association design practice of utilization of this strength.

The essence of present invention is in the more complete utilization of flexural strength of concrete than that provided by the current design practice. It is applied to the thickness design of airport critical and noncritical areas pavement with fatigue analysis according to said Portland Cement Association Engineering Bulletin, and can be applied to the thickness design of this pavement with other methods of fatigue analysis.

### DETAILED DISCRIPTION OF PREFFERED EMBODIMENT

Airport concrete pavement for aprons, taxiways, hard standings, runway ends for distance of 1,000 ft., and hangar floors as critical areas of airport is designed according to the invention with the preset strength safety level corresponding to strength safety index β equal at least about to 3. This estimation of strength safety is considered as required strength and criterion of sufficiency of claimed pavement in terms of strength safety. Thickness of pavement is determined by the results of fatigue analysis of pavement. Thickness design of pavement is carried out in framework of said Portland Cement Association Engineering Bulletin (Design of Concrete Airport Pavement, Portland Cement Association, EB 050P) with the use of values of safety factor in the range from 1.7 to 2.0. Thickness design procedure of this pavement provides more complete utilization of 90-day flexural strength of concrete considered as a random value than that provided by the current Portland Cement Association design procedure. As a result, thickness of claimed pavement is less by 8-10% as compared with the thickness of this pavement designed according to said Engineering Bulletin EB 050P. The mix design of concrete for pavement is determined by the value of 90-day modulus of rupture (MR) required by thickness design of this pavement according to said Engineering Bulletin.

More complete utilization of flexural strength of concrete means the carrying out of thickness design of pavement with the use of values of modulus of rupture exceeding values required according to the current Portland Cement Association design procedure. Increase of value of modulus of rupture means a possibility of reduction of thickness of pavement. Efficiency of more complete utilization of flexural strength of concrete depends on the preset strength safety of pavement as a required strength safety level of this pavement. Since thickness of pavement is determined by the requirements for fatigue strength, sufficiency of reduced thickness of pavement should be checked by results of fatigue analysis of pavement. There are a few methods of fatigue analysis of pavement. The most applicable of these methods is selected by the customer of construction (state Departments of Transportation, US Army, . . . ).

The choice of required strength safety of concrete pavement of airport critical areas is based on the processing of the data of test results of underreinforced prestressed floor and roof slabs designed according to the Russian building code, produced and tested at the Russian plants of precast concrete, mainly at the plants of the Moscow region (Sapozhnikov N. Strength Safety of Precast Reinforced Concrete and Prestressed Structural Members. State Committee of Construction of the USSR Institute of Information, Moscow, 1989, Table 12). The higher estimation of the strength safety of these slabs corresponding to the value of strength safety index β equal about to 3 was chosen as the required strength safety for claimed concrete pavement of airport critical areas. As indicated earlier, estimations of the strength safety of underreinforced slabs with the same service loads designed according to the American and Russian building codes are formally the same or nearly the same in spite of the different consumption of tension reinforcement required by the American and Russian building codes. It allows the use of the results of the strength safety analysis of these slabs for the choice of preset strength safety of airport concrete pavement.

Thickness of claimed pavement is less by 8-10% as compared with the thickness of this pavement designed completely according to said Engineering Bulletin EB 050P. It is achieved due to a more complete utilization of flexural strength of concrete than that provided by the current Portland Cement Association design practice of the utilization of this strength. More complete utilization of flexural strength of concrete considered as a random value means the use of increased values of the modulus of rupture as compared to that required by the current Portland Cement Association thickness design procedure. Thickness design of claimed pavement is carried out with the application of statistical methods of strength design basing on the statistical investigation of flexural strength in connection with the compressive strength of this concrete.

Statistical characteristics of flexural strength of concrete in connection with that for compressive strength were obtained by the processing data of American test results of 3,650 series of standard cylinders and beams, and American and British tests results of 1,107 series of modified cubes and standard beams. Coefficients of correlation between the compressive and flexural concrete strength are equal to 0.831 and 0.865 for these two samplings of the test results, respectively (Sapozhnikov N. Safety of Precast Reinforced Concrete and Prestressed Structural Members by the Second Limit State (Serviceability Limit State) State Committee of Construction of the USSR Institute of Information, Moscow, 1991, Table 6). Connections between compressive and flexural concrete strength, which correspond to these values of coefficient of correlation, can be considered statistically significant. It allows one to consider choice of the modulus of rupture of concrete (MR) as a specified flexural strength of concrete for pavement in connection with the specified compressive strength of this concrete.

Mean value of flexural strength of concrete fᵣ as a function of the mean value of compressive strength f_{c} of this concrete is equal to 9.42√f_{c}; this estimation is obtained from the comparative analysis of American test results of 3650 series of standard cylinders and beams of the same concrete. The values of the coefficient of variation for compressive and flexural strength of concrete are assumed as the same and equal to 15% for the calculation of the strength safety estimations of concrete pavement.

Since the main estimation of the compressive strength of concrete in the American building practice is cylinder strength, the modified cube strength was assessed as cylinder by dividing into 1.2; cube strength of concrete is higher than that of cylinder by 20% on average. The mean value of flexural strength of concrete as a function of the mean value of the modified cube compressive strength of this concrete f_{cu}^{mod} is equal to 9.53√f_{cu}^{mod}/1.2. This estimation of the mean value of flexural strength is obtained from the processing of the data of the test results of 1107 series of modified cubes and standard beams. As may be seen, the estimations of the mean value of flexural strength of concrete determined depending on the mean values of compressive cylindrical and modified cube strength of this concrete are very close and can be considered equivalent on average. It means that the modified cube compressive strength of concrete should be brought to the cylinder strength of this concrete by dividing by 1.2.

According to said American building code ACI 318, the required average compressive strength of concrete f′_{cr} has to exceed the specified compressive strength f_{c}′ at least by 1.34s(f_{c}), where S (f_{c}) is the standard deviation of this strength. Based on the value of coefficient of variation of concrete compressive strength equal to 15%, this excess can be estimated as 25% of the value of the specified compressive strength f_{c}′. The required average strength of concrete f_{cr} can be considered as a mean value of this strength f_{c}. This requirement of said American building code ACI 318 allows the estimation of the mean value of the compressive strength of concrete depending on the value of the specified compressive strength f_{c}′.

Due to close statistical connections between the compressive and flexural strengths of concrete, the mean value of flexural strength of concrete can be considered as stemming from that of compressive strength. Since the mean value of compressive strength of concrete corresponds to the value of specified compressive strength f_{c,}′ the mean value of flexural strength can be considered to be corresponding to this value of the specified compressive strength also. The definition of the specified compressive strength f_{c}′ relates to the 28-day cylindrical strength of concrete. The mean values of the compressive and flexural strengths of concrete determined depending on the specified compressive strength f_{c}′ of this concrete should be considered as statistical characteristics of the 28-day strength of concrete.

As is evident from the above, every value of specified compressive strength f_{c}′ corresponds to the mean values of 28-day compressive and flexural concrete strength, with the mean value of flexural strength being determined depending on the mean value of compressive strength of this concrete. It allows the estimation of the value of the 28-day modulus of rupture (MR) as a part of the mean value of the 28-day flexural strength of concrete depending on the corresponding value of the specified compressive strength f_{c}′.

Like the strength of any structural material, the flexural strength of concrete should be characterized by the specified and design strengths, with the design strength being estimated as a part of the specified strength. Said American building code ACI 318 and documents of the Portland Cement Association do not contain the definition of the specified flexural strength of concrete. According to the current procedure of thickness design of concrete pavements, modulus of rupture (MR) can be considered as the specified flexural strength of concrete, whereas the working stress as a part of modulus of rupture can be considered as the design flexural strength of this concrete.

According to Portland Cement Association Engineering Bulletin (Thickness Design for Concrete Highway and Street Pavements, Portland Cement Association, EB109P), modulus of rupture of concrete (MR) should be estimated as the average 28-day flexural strength value. The value of flexural strength multiplied by 50 psi, which is less than the experimental estimation of the mean value of flexural concrete strength but is nearest to it, should be chosen as the modulus of rupture (MR) of this concrete. If the mean value of flexural strength of concrete is determined according to the present invention depending on the specified compressive strength of this concrete, the procedure of estimation of the value of the modulus of rupture is the same.

According to said Portland Cement Association Engineering Bulletin (Design of Concrete Airport Pavement, Portland Cement Association, EB 050P), 90-day flexural strength of concrete is used for thickness design of airport pavements, and this value of flexural strength of concrete is estimated as 110% of 28-day strength. According to said Engineering Bulletin, 90-day flexural strength corresponding to the values of 28-day modulus of rupture (MR) in the range from 600 to 700 psi can be considered as sufficient for thickness design of airport concrete pavement. This range of 28-day flexural strength corresponds to values of modulus of rupture equal to 600, 650 and 700 psi. These values of the 28-day modulus of rupture (MR) were estimated as corresponding to the values of specified compressive strength f_{c}′ equal to 3,500, 4,000, and 4,500 psi, respectively. Mentioned values of the modulus of rupture constitute 0.962, 0.975, and 0.99 of the mean values of flexural strength corresponding to these values of specified compressive strength f_{c}′, respectively. It is necessary to estimate the strength safety of pavement of a certain stress ratio factor designed using these values of the modulus of rupture of concrete.

The statistical characteristics of 90-day flexural strength of concrete are considered as stemmed from that for 28-day flexural strength of this concrete. As indicated earlier, every value of specified compressive strength of concrete f_{c}′ corresponds to the mean value of 28-day flexural strength of this concrete. The mean value of 90-day flexural strength of concrete is considered as stemmed from that for 28-day flexural strength of this concrete. It allows considering of the mean value of 90-day flexural strength of concrete as corresponding to this value of specified compressive strength of concrete f_{c}′ also.

Availability of the mean value of 90-day flexural strength of concrete corresponding to the value of specified compressive strength f_{c}′ allows to estimate the value of 90-day modulus of rupture (MR) depending on this value of 28-day specified compressive strength. Value of 90-day modulus of rupture (MR) multiplied by 50 psi, which is less than the mean value of 90-day flexural concrete strength but is the nearest, can be considered as corresponding to this value of specified compressive strength f_{c}′. The values of 90-day modulus of rupture (MR) equal to 650, 700 and 750 psi were estimated as corresponding to the values of 28-day specified compressive strength f_{c}′ equal to 3.500, 4,000 and 4,500 psi, respectively. Mentioned values of modulus of rupture constitute 0.949, 0.955 and 0.965 of the mean values of flexural strength corresponding to these values of specified compressive strength f_{c}′, respectively.

Availability of statistical characteristics of 90-day flexural strength of concrete considered as stemmed from that for 28-day flexural strength of this concrete allows assessing of the safety of design flexural strength of concrete. Strength safety of pavement is defined as a probability P(fᵣ>MR/SF), where fᵣ is a 90-day flexural strength of concrete considered as a random value, MR/SF is working stress stress of concrete, MR is 90-day modulus of rupture of concrete considered as specified flexural strength, SF is safety factor of pavement in the range from 1.7 to 2.0. This value of working stress defined as a part of modulus of rupture (MR) is considered as design flexural strength of concrete. It means that strength safety of concrete pavement is equivalent to safety of design flexural strength of concrete.

Estimations of strength safety of pavement should be compared with the strength safety level required according to the invention and corresponding to the value of strength safety index β equal about to 3. Strength safety of pavement should be considered as excessive if it exceeds strength safety level required according to the invention. The availability of excessive strength safety of pavement means the possibility of more complete utilization of flexural strength of concrete of pavement designed according to said Engineering Bulletin.

Estimations of strength safety of pavement designed according to said Engineering Bulletin corresponding to values of 90-day modulus of rupture (MR) equal to 650, 700 and 750 psi are presented in the Table 1 in the form of strength safety index β. According to said Engineering Bulletin, safety factor for design of airport pavements of critical areas is the range from 2.0 to 1.7. As can be seen from the Table 1, estimations of strength safety of pavement designed with the use of these three values of modulus of rupture and the value of safety factor equal to 1.7 correspond to strength safety index β equal to 2.95, 2.92 and 2.87. These estimations of strength safety of pavement designed with the value of safety factor equal to 1.7 does not allow more complete utilization of flexural strength of concrete. Estimations of strength safety of pavement designed with the use of values of safety factor exceeding 1.7 correspond to values of strength safety index β exceeding 3. Availability of excessive strength safety level of pavement designed with the use of safety factor in the range from 1.8 to 2.0 means the possibility of more complete utilization of flexural strength of concrete.

As indicated earlier, more complete utilization of flexural strength of concrete considered as a random value means the use of greater values of modulus of rupture (MR) than that required by thickness design of this pavement according to said Engineering Bulletin. In so doing the mix design of concrete being determined by the value of modulus of rupture required by thickness design of this pavement according to said Engineering Bulletin. According to the invention, value of modulus of rupture provided by the current thickness design procedure and increased estimations of modulus of rupture are considered as representatives of distribution of density of probability of flexural strength of concrete. Due to close statistical connections between compressive and flexural strength of concrete distribution of density of probability of flexural strength of concrete can be considered as corresponding to specified compressive strength of this concrete f_{c}′ as well as the distribution of density of probability of compressive strength of this concrete. As a result, all mentioned estimations of modulus of rupture of this concrete as representatives of distribution of density of probability of flexural strength of concrete can be considered as corresponding to this value of specified compressive strength of concrete f_{c}′. In so doing the value of modulus of rupture of concrete provided by the current thickness design procedure just corresponds to the mean value of flexural strength and specified compressive strength of this concrete

The distribution of density of probability of flexural strength of concrete can be represented by few values of modulus of rupture (MR) considered as specified flexural strength of this concrete. Any of these values of modulus of rupture of concrete (MR) can be used for thickness design of claimed pavement with the certain value of safety factor, if estimation of strength safety of this pavement designed with the use of the certain value of safety factor and this value of modulus of rupture is not less than preset strength safety level of claimed pavement. As applied to thickness design of pavement of critical areas of airport, preset strength safety level corresponds to strength safety index β equal at least about to 3. In so doing strength safety of pavement is estimated depending on the values of modulus of rupture and safety factor of pavement.

According to the invention, three values of specified flexural strength of concrete (MR) differing by 50 psi are considered as representatives of distribution of density of probability of flexural strength of concrete corresponding to one value of specified compressive strength f_{c}′. The least of these three is the value of modulus of rupture (MR) required by the thickness design of pavement according to said Portland Cement Association Engineering Bulletin, and just this value of modulus of rupture (MR) corresponds to mentioned value of specified compressive strength f_{c}′. Two other values of modulus of rupture (MR) of these three should be considered as corresponding to this value of specified compressive strength f_{c}′ also, because they are considered as representatives of distribution of density of probability of flexural strength of concrete corresponding to this value of specified compressive strength. According to the invention, all three values of modulus of rupture (MR) can be used for fatigue analysis of claimed pavement, if estimations of strength safety of pavement designed with the use of these values of modulus of rupture correspond to strength safety level required according to the invention.

The strength safety estimations of concrete pavements in the form of strength safety indexes β are presented in Table 2 depending on value of safety factor, value of 28-day specified compressive cylindrical strength f_{c}′ and corresponding three values of 90-day modulus of rupture (MR) differing by 50 psi. Three estimations of strength safety of pavement in form of strength safety indexes β correspond to these three values of 90-day modulus of rupture of concrete (MR) stemmed from the one 28-day value specified compressive strength of this concrete f_{c}′ The least of these three estimations of strength safety of pavement corresponds to value of modulus of rupture (MR) required by the thickness design of this pavement according to said Portland Cement Association Engineering Bulletin. Calculation of estimations of strength safety of concrete pavements presented in the Table 2 was carried out with the use of the mean value fᵣ and standard deviation s(fᵣ) of flexural strength of concrete equal to 9.42√f_{c} and 0.15fᵣ, respectively. Mean value of compressive strength of concrete f_{c} being considered as required average strength defined according to said American building code ACI 318 (item 5.3.2.1).

Possibility of more complete utilization of flexural strength of concrete depends on the value of safety factor of pavement. As can be seen from the Table 2, more complete utilization of flexural strength for fatigue analysis of pavement designed with the use of safety factor equal to 1.7 is impossible since only estimation of strength safety of pavement corresponding to the least of three values of modulus of rupture of concrete corresponds to required strength safety of pavement. Fatigue analysis of pavement designed with the use of the safety factor equal to 1.8 should be carried out with the consecutive use of two values of modulus of rupture (MR) of three corresponding to one value of specified compressive strength f_{c}′. Fatigue analysis of pavement designed with the use of safety factor equal to 1.9 and 2.0 should be carried out with the consecutive use of three values of modulus of rupture (MR) corresponding to one value of specified compressive strength f_{c}′.

Thickness of claimed pavement is determined by requirements for fatigue strength. According to said Portland Cement Association Engineering Bulletin, method of reflection of fatigue effect for thickness design procedure depends on the possibility to forecast the traffic loads and volumes expected during the pavement's life. If estimation of these factors is based on general knowledge of number of load applications expected during the pavement's life, fatigue effect should be reflected by selection of conservative value of safety factor in the range from 1.7 to 2.0. This is valid procedure for design of most pavements, when appropriate factors are chosen to reflect future increases in the volumes, weights, and channelization of aircraft to be served. If specific forecast of traffic loads and volumes have been determined, pavement should be designed with the more detailed analysis of fatigue effect according to of said Engineering Bulletin.

According to the invention, thickness design of claimed pavement should begin with the estimation of values of thickness of pavement corresponding to all values of safety factor in the range from 1.7 to 2.0. This design procedure should be carried out regardless of fatigue effect with more complete utilization of flexural strength of concrete than that provided by the current design practice. Sufficiency of pavement of these values of thickness should be checked by requirements for fatigue strength of pavement.

If forecast of the traffic loads and volumes is based on the general knowledge of number of load applications expected during the pavement's life, fatigue analysis should begin with the pavement of thickness corresponding to the most conservative value of safety factor in the range from 2.0 to 1.7. If results of fatigue analysis of pavement with the thickness corresponding to the value of safety factor equal to 2.0 meet requirements of fatigue analysis, the same procedure should be carried out with the pavement of thickness corresponding to the value of safety factor equal to 1.9. This procedure should be carried out in the range of values of safety factor from 2.0 to 1.7 as long as results of fatigue analysis of pavement do not meet requirements of fatigue analysis.

Thickness design of pavement with the specific forecast of traffic loads and volumes is the same, but control of sufficiency of estimations of thickness corresponding to all values of safety factor in the range from 1.7 to 2.0 should begin with the least value of safety factor in this range. If results of fatigue analysis of pavement of thickness corresponding to the value of safety factor equal to 1.7 do not meet requirements of fatigue analysis, the same procedure should be carried out with the pavement of thickness corresponding to value of safety factor equal to 1.8. This procedure should be carried out with the values of safety factor in the range from 1.7 to 2.0 as long as results of fatigue analysis of pavement meet requirements of fatigue analysis. Minimum value of thickness of pavement designed with the use of the values of safety factor in this range and corresponding to requirements of fatigue analysis is considered as acceptable.

According to the invention, fatigue analysis of pavement should be carried out according to the most detailed version of the current Portland Cement Association design procedure or with the use of other methods of fatigue analysis according to the requirements of the customer by the consecutive use of three values of 90-day modulus of rupture (MR) with the difference of 50 psi corresponding to one value of 28-day specified compressive strength of concrete f_{c}′. The least of these three is the value of modulus of rupture (MR) required by thickness design of this pavement according to said Engineering Bulletin just corresponding to this value of 28-day specified compressive strength of concrete f_{c}′. If strength safety of pavement designed with the use of certain value of safety factor and any of these three values of specified flexural strength (MR) is less than that required by this invention, this value of specified flexural strength (MR) can not be used for fatigue analysis of pavement. Results of fatigue analysis of claimed pavement should meet requirements of the most detailed version of the current Portland Cement Association design procedure or other method of fatigue analysis applied to the thickness design of pavement.

The efficiency of more complete utilization of flexural strength of concrete can be estimated by examples of design of concrete pavements of critical airport areas (design charts FIGS. 13 and 14 of said Portland Cement Association Engineering Bulletin). The forecast of the traffic loads and volumes of these pavements is based on the general knowledge of number of load applications expected during the pavement's life. These pavements were designed according to said Engineering Bulletin with the most conservative in the range from 1.7 to 2.0 value of safety factor. Estimations of thickness of these pavements determined with more complete utilization of flexural strength of concrete regardless of fatigue effect are by 9.3% less than values of thickness of these pavements determined according to said Engineering Bulletin. According to said Portland Cement Association Engineering Bulletin, concrete has a flexural fatigue endurance limit at a stress ratio of approximately 0.55. Stress ratio factor of pavement corresponding to the values of safety factor in the range from 2.0 to 1.8 does not exceed 0.55. It allows to estimate the efficiency of more complete utilization of flexural strength of concrete of pavement of airport critical areas as a possibility of reduction of thickness of this pavement by 8-10% as compared with that provided by the thickness design of this pavement according to said Portland Cement Association Engineering Bulletin. This is very conservative estimation; more complete utilization of flexural strength of concrete of pavement designed with the use of the value of safety factor equal to 1.8 (design charts FIG. 15 of said Engineering Bulletin) allows reduction of 6.1% of the thickness provided by the thickness design of this pavement according to said Engineering Bulletin.

More complete utilization of flexural strength of concrete considered as a random value allows to obtain more accurate estimation of fatigue strength of pavement than that provided by the Portland Cement Association design procedure. As a result, the thickness of claimed pavement can be reduced at least by 8-10% as compared with that provided by the thickness design of this pavement according to said Portland Cement Association Engineering Bulletin.

Moreover, revaluation of strength safety and fatigue strength of existing airport pavements for increasing of allowable aircraft loads is possible due to more complete utilization of flexural strength of concrete than that provided by the current Portland Cement Association design practice of utilization of this strength.

The essence of present invention is in the more complete utilization of flexural strength of concrete than that provided by the current design practice. It is applied to the thickness design of airport critical areas pavement with fatigue analysis according to said Portland Cement Association Engineering Bulletin and can be applied to the thickness design of this pavement with other methods of fatigue analysis.

### Operation of Preferred Embodiment

According to the invention, design of airport pavement begins from the choice of the one of three values of 90-day modulus of rupture of concrete (MR) equal to 650, 700 and 750 psi corresponding to the values of 28-day specified compressive strength of concrete f_{c}′ equal to 3,500, 4,000 and 4,500 psi, respectively. This choice is determined by domestic conditions, mainly by the quality of coarse aggregate. Thickness design of pavement should be provided with preset strength safety level corresponding to values of strength safety index β equal at least to about 3.

According to the invention, thickness design of claimed pavement should begin with the estimation of the values of thickness of this pavement corresponding to all values of safety factor in the range from 1.7 to 2.0. This design procedure should be carried out regardless of fatigue effect with more complete utilization of flexural strength of concrete than that provided by the current design practice by the use of the values of modulus of rupture exceeding the mean value of flexural strength of concrete. More complete utilization of flexural strength of concrete is possible if strength safety of pavement of thickness corresponding to the certain value of safety factor and increased value of modulus of rupture corresponds to the preset strength safety level required according to the invention.

As can be seen from the Table 2, each value of 28-day specified compressive strength of concrete f_{c}′ corresponds to three values of 90-day specified flexural strength of concrete (MR) with the difference of 50 psi. The least of these three being the value of modulus of rupture (MR) required by the thickness design of pavement according to said Portland Cement Association Engineering Bulletin. Three estimations of strength safety of pavement in form of strength safety indexes β correspond to these three values of modulus of rupture (MR). Any value of modulus of rupture of concrete (MR) of these three can be used for fatigue analysis of claimed pavement, if strength safety of pavement designed with the use of certain value of safety factor and this value of modulus of rupture (MR) if strength safety of this pavement corresponds to to strength safety index β equal at least to about 3.

Possibility of utilization of flexural strength of concrete for fatigue analysis of pavement depends on the value of safety factor. Three of the three values of modulus of rupture corresponding to the one value of the 28-day specified compressive strength f_{c}′ can be used for fatigue analysis of pavement designed with the use of values of safety factor equal to 2.0 and 1.9. Two of these three values of modulus of rupture corresponding to the one value of the 28-day specified compressive strength f_{c}′ can be used for fatigue analysis of pavement designed with the use of values of safety factor equal to 1.8. More complete utilization of flexural strength for fatigue analysis of pavement designed with the use of safety factor equal to 1.7 is impossible; only estimation of strength safety of pavement designed using the least of three values of modulus of rupture of concrete corresponds to required strength safety of pavement. Thus, more complete utilization of flexural strength of concrete than that provided by the current design practice for fatigue analysis of airport critical areas pavement is possible for thickness design of this pavement with the values of safety factor in the range from 1.8 to 2.0.

Sufficiency of pavement of values of thickness determined regardless of fatigue effect should be checked by results of fatigue analysis carried out with more complete utilization of flexural strength of concrete considered as a random value than that provided by the current design practice. Fatigue analysis of this pavement should be carried out according to the most detailed version of the current Portland Cement Association design procedure or other method of fatigue analysis applied to the thickness design of pavement with the consecutive use of three of the three values of modulus of rupture (MR) corresponding to the one value of the 28-day specified compressive strength f_{c}′ Thickness of pavement should be considered satisfactory if results of fatigue analysis of the pavement of this thickness meet requirements of this analysis.

According to said Portland Cement Association Engineering Bulletin, fatigue effect basing on general knowledge of number of load applications expected during the pavement's life should be reflected by selection of conservative value of safety factor in the range from 1.7 to 2.0. According to the invention, sufficiency of pavement of thickness corresponding to the all values of safety factor in this range determined regardless of fatigue effect with more complete utilization of flexural strength of concrete should be checked by results of fatigue analysis beginning with the pavement of thickness corresponding to value of safety factor equal to 2.0. If results of fatigue analysis meet requirements of of this analysis, the same procedure with consecutive use of three values of modulus of rupture (MR) should be carried out with the pavement of thickness corresponding to the value of safety factor equal to 1.9. If results of fatigue analysis meet requirements of this fatigue analysis, the same procedure with consecutive use of two values of modulus of rupture (MR) should be carried out with the thickness of pavement corresponding to value of safety factor equal to 1.8. If results of fatigue analysis of pavement of thickness corresponding to the value of safety factor equal to 1.8 meet requirements of this analysis, fatigue analysis of pavement of thickness corresponding to the value of safety factor equal to 1.7 should be carried out. This procedure should be carried out in the range of safety factor from 2.0 to 1.7 as long as results of fatigue analysis of pavement do not meet requirements of of the most detailed version of the current Portland Cement Association design procedure or other method of fatigue analysis applied to the thickness design of pavement.

Design procedure of concrete pavement of critical areas of airport with the specific forecast of traffic loads and volumes is the same, but it should begin with the pavement of thickness corresponding to the least value of safety factor equal to 1.7. Fatigue analysis of pavement of thickness corresponding to this value of safety factor should be carried out with the use of the least of three values of modulus of rupture (MR) required by thickness design of this pavement according to said Engineering Bulletin. If results of fatigue analysis of this pavement do not meet requirements of this fatigue analysis, this procedure should be repeated as applied to pavement of thickness corresponding to the value of safety factor equal to 1.8. Fatigue analysis of this pavement should be carried out with the consecutive use of two of three values of modulus of rupture (MR) corresponding to one value of 28-day specified compressive strength of concrete f_{c}′. If results of the fatigue analysis of this pavement are inadequate, the same procedure with consecutive use of three values of modulus of rupture (MR) should be carried out as applied to pavement of thickness corresponding to the value of safety factor equal to 1.9. This procedure should be carried out in the range of safety factor from 1.7 to 2.0 as long as results of fatigue analysis of pavement meet requirements of the most detailed version of the current Portland Cement Association design procedure or other method of fatigue analysis applied to the thickness design of pavement. Minimum value of thickness of pavement designed with the use of the values of safety factor in the range from 1.7 to 2.0 with satisfactory results of fatigue analysis should be considered as sufficient.

### Additional Embodiment of Invention

Airport concrete pavement for runways (central portion) and some high-speed exit taxiways as noncritical areas of airport according to the invention is designed with preset strength safety level corresponding to strength safety index β equal at least to about 2.5. Thickness of pavement is determined by the results of fatigue analysis of pavement. Thickness design of pavement is carried out in framework of said Portland Cement Association Engineering Bulletin (Design of Concrete Airport Pavement, Portland Cement Association, EB 050P) with the use of values of safety factor in the range from 1.5 to 1.7 with more complete utilization of flexural strength of concrete considered as a random value than that provided by the current Portland Cement Association design procedure. Estimation of strength safety of pavement corresponding to the value of safety factor equal to 1.4 is less than preset strength safety level of pavement of noncritical areas, and this value o safety factor can not be used for thickness design of claimed pavement. The mix design of concrete for pavement is determined by the value of 90-day modulus of rupture (MR) required by thickness design of this pavement according to said Engineering Bulletin.

Thickness of claimed pavement is less by 5-10% as compared with the thickness of this pavement designed according to said Engineering Bulletin EB 050P. It is achieved due to a more complete utilization of flexural strength of concrete considered as a random value than that provided by the current Portland Cement Association design practice of the utilization of this strength. It means the use of the values of the modulus of rupture exceeding the mean value of flexural strength for fatigue analysis of pavement. Thickness design procedure for pavements of airport noncritical and critical areas is the same but with the different values of required strength safety level.

According to the invention, fatigue analysis of pavement should be carried out according to the most detailed version of the current Portland Cement Association design procedure or with the use of other methods of fatigue analysis according to the requirements of the customer by the consecutive use of three or two values of modulus of rupture (MR) with the difference of 50 psi corresponding to the one value of specified compressive strength. The least of these three is the value of modulus of rupture (MR) required by thickness design of this pavement according to said Engineering Bulletin. If pavement designed with the use of the certain value of safety factor and any of these three values of specified flexural strength (MR) has the strength safety level less than that required by the invention, this value of specified flexural strength (MR) can not be used for fatigue analysis of pavement. Results of fatigue analysis of claimed pavement should meet requirements of the most detailed version of the current Portland Cement Association design procedure or other method of fatigue analysis applied to the thickness design of pavement.

The possibility of utilization of flexural strength considered as a random value depends on the value of safety factor of pavement. As can be seen from the Table 2, more complete utilization of flexural strength of pavement designed using safety factor equal to 1.5 for fatigue analysis of this pavement is impossible since only estimation of strength safety of pavement corresponding to the least of three values of modulus of rupture of concrete corresponds to required strength safety of pavement. Fatigue analysis of pavement of thickness corresponding to the safety factor equal to 1.6 should be carried out using two values of modulus of rupture (MR) with the difference of 50 psi. Fatigue analysis of pavement of thickness corresponding to safety factor equal to 1.7 should be carried out using three values of modulus of rupture (MR) of three corresponding to one value of specified compressive strength f_{c}′.

According to the invention, thickness design of claimed pavement should begin with the estimation of values of thickness of pavement corresponding to all values of safety factor in the range from 1.5 to 1.7. This design procedure should be carried out regardless of fatigue effect with more complete utilization of flexural strength of concrete than that provided by the current design practice. Sufficiency of pavement of these values of thickness should be checked by requirements for fatigue strength of pavement; more complete utilization of flexural strength of concrete considered as a random value and corresponding reduction of thickness of pavement is possible only in connection with fatigue analysis of this pavement.

If forecast of the traffic loads and volumes is based on the general knowledge of number of load applications expected during the pavement's life, fatigue analysis should begin with the pavement of thickness corresponding to the most conservative value of safety factor in the range from the 1.5 to 1.7. If results of fatigue analysis of pavement with the thickness corresponding to value of safety factor equal to 1.7 meet requirements of fatigue analysis, the same procedure should be provided with the pavement with the thickness corresponding to value of safety factor equal to 1.6. This procedure should be carried out in the range of values of safety factor from 1.7 to 1.5 as long as results of fatigue analysis of pavement do not meet requirements of the most detailed version of fatigue analysis of the current Portland Cement Association design procedure or other method of fatigue analysis applied to the thickness design of pavement.

Thickness design procedure of pavement with the specific forecast of traffic loads and volumes is the same. However fatigue analysis of pavement should begin with the pavement of thickness corresponding to the least value of safety factor in the range from 1.4 to 1.7. If results of fatigue analysis of pavement with the thickness corresponding to value of safety factor equal to 1.5 do not meet requirements of fatigue analysis, the same procedure should be carried out with the pavement with the thickness corresponding to value of safety factor equal to 1.6. This procedure should be carried out with the values of safety factor in the range from 1.4 to 1.7 as long as results of fatigue analysis of pavement meet requirements of the most detailed version of fatigue analysis of the current Portland Cement Association design procedure or other method of fatigue analysis applied to the thickness design of pavement. Minimum value of thickness of pavement designed with the use of the values of safety factor in this range and corresponding to requirements of fatigue analysis is considered as acceptable.

According to the invention, more complete utilization of flexural strength of concrete considered as a random value allows to obtain more accurate estimation of fatigue strength of pavement than that provided by the Portland Cement Association design procedure. As a result, the thickness of claimed pavement can be reduced at least by 5-10% as compared with that provided by the thickness design of this pavement according to said Engineering Bulletin.

Moreover, revaluation of strength safety and fatigue strength of existing airport pavements for increasing of allowable aircraft loads is possible due to more complete utilization of flexural strength of concrete than that provided by the current Portland Cement Association design practice of utilization of this strength.

The essence of present invention is in the more complete utilization of flexural strength of concrete than that provided by the current design practice. It is applied to the thickness design of airport noncritical areas pavement with fatigue analysis according to said Portland Cement Association Engineering Bulletin and can be applied to the thickness design of this pavement with other methods of fatigue analysis.

### Operation of Additional Embodiment

According to the invention, design of airport pavement begins from the choice of one of three values of 90-day modulus of rupture of concrete (MR) equal to 650, 700 and 750 psi corresponding to values of 28-day specified compressive strength of concrete f_{c}′ equal to 3,500, 4,000 and 4,500 psi, respectively. This choice is determined by domestic conditions, mainly by the quality of coarse aggregate.

According to said Portland Cement Association Engineering Bulletin concrete pavement of airport critical areas should be designed with the use of safety factor in the range from 1.4 to 1.7. Estimation of strength safety of pavement corresponding to the value of safety factor equal to 1.4 is less than preset strength safety level of pavement of noncritical areas, and this value o safety factor can't be used for thickness design of claimed pavement.

According to the invention, thickness design of claimed pavement should begin with the estimation of values of thickness of pavement corresponding to all values of safety factor in the range from 1.5 to 1.7. This design procedure should be carried out regardless of the fatigue effect with more complete utilization of flexural strength of concrete than that provided by the current design practice by the use of the values of modulus of rupture exceeding the mean value of flexural strength of concrete. More complete utilization of flexural strength of concrete is possible if strength safety of pavement of thickness corresponding to increased value of modulus of rupture is no less than strength safety level required according to the invention.

As can be seen from the Table 2, each value of 28-day specified compressive strength of concrete f_{c}′ corresponds to three values of 90-day specified flexural strength of concrete (MR) differing by 50 psi. The least of these three is the value of modulus of rupture (MR) required by the thickness design of pavement according to said Portland Cement Association Engineering Bulletin. Three estimations of strength safety of pavement in form of strength safety indexes β correspond to these three values of modulus of rupture (MR). Any value of modulus of rupture of concrete (MR) of these three can be used for fatigue analysis of claimed pavement, if strength safety of pavement designed with the use of this value of modulus of rupture (MR) can be considered as sufficient in terms of strength safety of claimed pavement. As applied to claimed pavement of airport noncritical areas, sufficiency of pavement in terms of strength safety means strength safety of this pavement corresponding to strength safety index β equal at least to about 2.5.

Possibility of utilization of flexural strength of concrete for fatigue analysis of pavement depends on the value of safety factor. Three of these three values of modulus of rupture corresponding to one value of 28-day specified compressive strength f_{c}′ can be used for fatigue analysis of pavement designed with the use of values of safety factor equal to 1.7. Two of these three values of modulus of rupture can be used for fatigue analysis of pavement designed with the use of values of safety factor equal to 1.6. More complete utilization of flexural strength for fatigue analysis of pavement designed with the use of safety factor equal to 1.5 is impossible; only estimation of strength safety of pavement designed using the least of three values of modulus of rupture of concrete corresponds to required strength safety of pavement. Thus, more complete utilization of flexural strength of concrete for fatigue analysis of airport noncritical areas pavement is possible for thickness design of this pavement with the values of safety factor equal to 1.6 and 1.7.

Sufficiency of pavement of these values of thickness in terms of fatigue strength should be checked by results of fatigue analysis carried out with more complete utilization of flexural strength of concrete considered as a random value. Fatigue analysis of this pavement should be carried out according to the most detailed version of the current Portland Cement Association design procedure or other method of fatigue analysis applied to the thickness design of pavement with the consecutive use of three or less of the three values of modulus of rupture (MR) corresponding to the one value of the 28-day specified compressive strength f_{c}′ Thickness of pavement should be considered satisfactory if results of fatigue analysis of the pavement of this thickness meet requirements of this analysis.

According to said Portland Cement Association Engineering Bulletin, fatigue effect basing on general knowledge of number of load applications expected during the pavement's life should be reflected by selection of conservative value of safety factor in the range from 1.4 to 1.7. According to the invention, sufficiency of pavement of thickness corresponding to values of safety factor in the range from 1.5 to 1.7 in terms of fatigue strength should be checked by results of fatigue analysis. This analysis should begin with the thickness of pavement corresponding to the most conservative value of safety factor equal to 1.7. Fatigue analysis of the pavement of thickness corresponding to value of safety factor equal to 1.7 should be carried out with the consecutive use of the three values of modulus of rupture with difference of 50 psi. If results of fatigue analysis meet requirements of this analysis, the same procedure should be carried out for the pavement of thickness corresponding to the value of safety factor equal to 1.6. This design procedure should be carried out with consecutive use of two values of modulus of rupture (MR) with difference of 50 psi. If results of fatigue analysis of this pavement are satisfactory, fatigue analysis of the pavement of thickness corresponding to value of safety factor equal to 1.5 should be carried out with the use of the least of three values of modulus of rupture. This procedure should be carried out in the safety factor range from 1.7 to 1.5 as long as results of fatigue analysis of pavement do not meet requirements of the most detailed version of the current Portland Cement Association design procedure or other method of fatigue analysis applied to the thickness design of pavement.

Design procedure of concrete pavement of noncritical areas of airport with the specific forecast of traffic loads and volumes is the same, but it should begin with the pavement of thickness corresponding to the least value of safety factor equal to 1.5. Fatigue analysis of pavement of thickness corresponding to this value of safety factor should be carried out with the use of the least of the three values of modulus of rupture corresponding to one value of 28-day specified compressive strength f_{c}′. If results of fatigue analysis of this pavement are inadequate, this procedure should be repeated as applied to the pavement of thickness corresponding to the value of safety factor equal to 1.6. Fatigue analysis of this pavement should be carried out with the consecutive use of two of three values of modulus of rupture differing by 50 psi. If results of fatigue analysis of this pavement are inadequate, the same procedure with consecutive use of three values of modulus of rupture differing by 50 psi should be provided with the pavement of thickness corresponding to the value of safety factor equal to 1.7. This procedure should be carried out in the range of safety factor from 1.5 to 1.7 as long as results of fatigue analysis of pavement meet requirements of the most detailed version of the current Portland Cement Association design procedure or other method of fatigue analysis applied to the thickness design of pavement.

Minimum value of thickness of pavement designed with the use of the values of safety factor in this range and corresponding to requirements of fatigue analysis is considered as acceptable.

### CONCLUSION

Concrete pavement for aprons, taxiways, hard standings, runway ends for distance of 1,000 ft., hangar floors as critical areas of airport and concrete pavement for runways (central portion) and some high-speed exit taxiways as noncritical areas of airport are designed with the preset strength safety level corresponding to values strength safety index β equal at least to about 3 and 2.5, respectively. These estimations of strength safety are considered as criteria of sufficiency of claimed pavements in terms of strength safety. According to said Portland Cement Association Engineering Bulletin (Design of Concrete Airport Pavement, Portland Cement Association, EB 050P), these pavements should be designed with the use of values of safety factor in the ranges from 1.7 to 2.0 and from 1.4 to 1.7, respectively. Estimation of strength safety of pavement corresponding to value of safety factor equal to 1.4 is less than preset strength safety level of pavement of noncritical areas. According to the invention, this value o safety factor can not be used for thickness design of claimed pavement of noncritical areas of airport.

Thickness of claimed pavements is controlled by results of fatigue analysis. This thickness is less by 8-10% and 5-10% for critical and noncritical areas of airport, respectively, than that provided by thickness design of these pavements according to said Portland Cement Association Engineering Bulletin. Reduction of thickness of the each of claimed pavement was achieved by the carrying out of fatigue analysis of pavement with more complete utilization of flexural strength of concrete considered as a random value then that provided by the current Portland Cement Association design practice of utilization of this strength. Mix design of concrete is determined by the value of modulus of rupture (MR) required by the thickness design of this pavement according to said Portland Cement Association Engineering Bulletin.

More complete utilization of flexural strength of concrete considered as a random value means the use of values of modulus of rupture (MR) exceeding the mean value of flexural strength. According to the invention, any value of modulus of rupture (MR) considered as specified flexural strength of concrete can be used for fatigue analysis of claimed pavement designed with the certain value of safety factor, if strength safety of this pavement corresponds to required strength safety level. Required strength safety levels of claimed pavements were chosen basing on the strength safety analysis of structural members (Sapozhnikov N. Strength Safety of Precast Reinforced Concrete and Prestressed Structural Members. State Committee of Construction of the USSR Institute of Information, Moscow, 1989, Tables 12 and 24).

More complete utilization of flexural strength of concrete of claimed pavements then that provided by the current Portland Cement Association design procedure is based on the results of statistical investigation of flexural strength of concrete in connection with the compressive strength of this concrete. This investigation was carried out by the processing data of the American test results of compressive and flexural concrete strength (Sapozhnikov N. Safety of Precast Reinforced Concrete and Prestressed Structural Members by the Second Limit State (Serviceability Limit State). State Committee of Construction of the USSR Institute of Information, Moscow, 1991, Table 6).

According to said Portland Cement Association Engineering Bulletin, fatigue effect basing on general knowledge of number of load applications expected during the pavement's life should be reflected by selection of conservative value of safety factor. According to the invention, fatigue analysis of pavement should be carried out according to the most detailed version of the current Portland Cement Association design procedure or with the use of other methods of fatigue analysis according to the requirements of the customer with the more complete utilization of flexural strength of concrete. It is provided by the consecutive use of three or less values of modulus of rupture (MR) considered as specified flexural strength of concrete (MR) with the difference of 50 psi. The least of these three values is the value of modulus of rupture (MR) required by thickness design of this pavement according to said Engineering Bulletin. Fatigue analysis of pavement with the specific forecast of traffic loads and volumes should be carried out by the same manner.

Possibility of the use of three or even two values of modulus of rupture (MR) with the difference of 50 psi instead the one the least of these three for fatigue analysis of claimed pavement means the significant increase of degree of utilization of flexural strength of concrete. More complete utilization of flexural strength of concrete allows to obtain more exact estimation of fatigue strength of concrete and to reduce the thickness of claimed pavement by 8-10% as compared with that provided by thickness design of these pavements according to said Engineering Bulletin of Portland Cement Association.

Moreover, revaluation of strength safety and fatigue strength of existing airport pavements for increasing of allowable aircraft loads is possible due to more complete utilization of flexural strength of concrete than that provided by the current Portland Cement Association design practice of utilization of this strength.

The essence of present invention is in the more complete utilization of flexural strength of concrete than that provided by the current design practice. It is applied to the thickness design of airport critical and noncritical areas pavement with fatigue analysis according to said Portland Cement Association Engineering Bulletin, and can be applied to the thickness design of this pavement with other methods of fatigue analysis.

Furthermore, consideration of statistical connections between compressive and flexural strength of concrete allows to choose value of modulus of rupture of concrete (MR) required by the thickness design of claimed pavement according to said Portland Cement Association Engineering Bulletin in connection with the corresponding values of specified flexural strength f_{c}′. It allows to carry out design of composition of concrete for claimed pavement which should be determined by this value of modulus of rupture (MR), by means of the corresponding value of specified flexural strength f_{c}′. It makes design of concrete composition more convenient, because compressive strength of concrete is common employed and well-studied as compared with that for flexural strength.

It will be understood that although preferred embodiments of the present invention have been shown and described, varies modifications thereof will be apparent to those skilled in art, and, accordingly, the scope of the present invention should be defined only by the appended claims and equivalents thereof.

Table 1. The strength safety estimations of airport concrete pavement in form of strength safety index β assessed depending on the specified compressive strength f_{c}′ and corresponding values of 90-day modulus of rupture (MR) considered as specified flexural strength of concrete

Safety

| factor/ | Specified compressive concrete strength fc′ (psi) | | |
|---|---|---|---|
| Stress | 3,000 | 3,500 | 4,000 |
| ratio | 90-day modulus of rupture MR (psi) | | |
| factor | 650 | 700 | 750 |
| 2.0/0.5 | 3.5 | 3.48 | 3.45 |
| 1.9/0.526 | 3.34 | 3.31 | 3.28 |
| 1.8/0.555 | 3.15 | 3.13 | 3.10 |
| 1.7/0.588 | 2.95 | 2.92 | 2.87 |
| 1.6/0.625 | 2.71 | 2.69 | 2.65 |
| 1.5/0.666 | 2.46 | 2.43 | 2.38 |
| 1.4/0.714 | 2.15 | 2.13 | 2.07 |

Remarks to Table 1; According to Portland Cement Association Engineering Bulletin (Design of Concrete Airport Pavement, Portland Cement Association, EB 050P), values of 90-day values of modulus of rupture (MR) equal to 650, 700, and 750 psi corresponding to 28-day flexural strength in the range from 600 to 700 psi are used for thickness design of airport pavements, with 90-day flexural strength of concrete being estimated as 110 percent of 28-day strength.

Table 2. The strength safety estimations of airport concrete pavement in form of strength safety index β corresponding to one value of specified compressive strength of concrete f_{c}′ and three values of 90-day modulus of rupture (MR), with less of these three being the value of modulus of rupture required by current Portland Cement Association thickness design procedure.

| Safety | | | | | | | | | |
|---|---|---|---|---|---|---|---|---|---|
| factor/ | Specified 28-day compressive concrete strength fc′ (psi) | | | | | | | | |
| Stress | 3,500 | | | 4,000 | | | 4,500 | | |
| ratio | 90-day modulus of rupture of concrete MR (psi) | | | | | | | | |
| factor | 650 | 700 | 750 | 700 | 750 | 800 | 750 | 800 | 850 |
| 2.0/ | 3.50 | 3.26 | 3.02 | 3.48 | 3.25 | 3.02 | 3.45 | 3.24 | 3.02 |
| 0.5 | | | | | | | | | |
| 1.9/ | 3.34 | 3.09 | 2.83 | 3.31 | 3.08 | 2.84 | 3.28 | 3.06 | 2.83 |
| 0.526 | | | | | | | | | |
| 1.8/ | 3.15 | 2.89 | 2.62 | 3.13 | 2.88 | 2.63 | 3.10 | 2.86 | 2.62 |
| 0.555 | | | | | | | | | |
| 1.7/ | 2.95 | 2.66 | 2.38 | 2.92 | 2.66 | 2.39 | 2.87 | 2.63 | 2.38 |
| 0.588 | | | | | | | | | |
| 1.6/ | 2.71 | 2.41 | 2.1 | 2.69 | 2.40 | 2.12 | 2.65 | 2.38 | 2.11 |
| 0.625 | | | | | | | | | |
| 1.5/ | 2.46 | 2.13 | 1.81 | 2.43 | 2.12 | 1.82 | 2.38 | 2.10 | 1.81 |
| 0.666 | | | | | | | | | |
| 1.4/ | 2.15 | 1.80 | 1.46 | 2.13 | 1.80 | 1.47 | 2.07 | 1.77 | 1.46 |
| 0.714 | | | | | | | | | |

Remarks to Table 2; 1. According to Portland Cement Association Engineering Bulletin (Design of Concrete Airport Pavement, Portland Cement Association, EB 050P), values of 90-day values of modulus of rupture (MR) equal to 650, 700, and 750 psi corresponding to 28-day flexural strength in the range from 600 to 700 psi are used for thickness design of airport pavements, with 90-day flexural strength of concrete being estimated as 110 percent of 28-day strength.

2. Three values of modulus of rupture (MR) corresponding to one value of specified compressive concrete strength f_{c}′ considered as specified flexural strength of concrete and representatives of distribution of density of probability of flexural strength can be used for fatigue analysis of pavement to realize more complete utilization of flexural strength of concrete as a random value. The less of these three is the value of modulus of rupture required by thickness design of this pavement according to said Engineering Bulletin.

1. Airport concrete pavement for aprons, taxiways, hard standings, runway ends for distance of 1,000 ft, and hangar floors as critical areas of airport of the preset strength safety level corresponding to the value of strength safety index β equal at least to about 3, with the thickness determined by results of fatigue analysis which is less by 8-10% than the thickness of this pavement provided by the current Portland Cement Association design procedure due to more complete utilization of flexural strength of concrete than that provided by the current Portland Cement Association design practice of utilization of this strength for carrying out of fatigue analysis of pavement in the framework of said design procedure or with the use of other methods of fatigue analysis according to the requirements of the customer, more complete utilization of flexural strength of concrete considered as a random value means the use of values of modulus of rupture exceeding the mean value of flexural strength for thickness design of pavement, mix design of concrete of pavement being determined by value of 90-day modulus of rupture (MR) required by the thickness design according to said design procedure, fatigue analysis of pavement is carried out with consecutive use of few 90-day values of modulus of rupture of concrete (MR) considered corresponding to the one value of 28-day specified compressive strength of this concrete f_{c}′, the least of these few values just corresponding to this value of 28-day specified compressive strength is the value of modulus of rupture (MR) required by the thickness design of this pavement according to said design procedure, any of these few values of modulus of rupture of concrete (MR) can be used for fatigue analysis of pavement if strength safety of this pavement designed with the use of the certain value of safety factor and this value of modulus of rupture corresponds to the preset strength safety of pavement.

2. Concrete pavement of airport critical areas of claim 1 with the thickness determined by results of fatigue analysis, fatigue analysis of pavement regardless of forecast of traffic loads and volumes expected during the pavement's design life should be carried out according to the most detailed version of the current Portland Cement Association design procedure or with the use of other methods of fatigue analysis according to the requirements of the customer with more complete utilization of flexural strength of concrete considered as a random value than that provided by the current Portland Cement Association design practice of utilization of this strength by the consecutive use of three values of 90-day modulus of rupture of concrete (MR) with the difference of 50 psi, the least of these three values of modulus of rupture is the value of modulus of rupture (MR) required by thickness design of this pavement according to the current Portland Cement Association thickness design procedure, any of these three value of modulus of rupture of concrete (MR) can be used for fatigue analysis of claimed pavement if estimation of strength safety of this pavement designed with the use of the certain value of safety factor and this value of modulus of rupture corresponds to the value of strength safety index β equal at least to about 3, sufficiency of thickness of pavement determined regardless of fatigue effect with the use of the values of safety factor in the range from 1.7 to 2.0 with more complete utilization of flexural strength of concrete considered as a random value than that provided by the current Portland Cement Association design practice of utilization of this strength should be checked by results of fatigue analysis of this pavement.

3. Airport concrete pavement for runways (central portion) and some high-speed exit taxiways as noncritical areas of airport of the preset strength safety level corresponding to value of strength safety index β equal at least to about 2.5 with the thickness determined by results of fatigue analysis which is less by 5-10% than the thickness of this pavement provided by the current Portland Cement Association design procedure due to more complete utilization of flexural strength of concrete than that provided by the current Portland Cement Association design practice of utilization of this strength for carrying out of fatigue analysis of pavement in the framework of said design procedure or with the use of other methods of fatigue analysis according to the requirements of the customer, more complete utilization of flexural strength of concrete considered as a random value means the use of values of modulus of rupture exceeding the mean value of flexural strength for thickness design of pavement, mix design of concrete of pavement being determined by value of the 90-day modulus of rupture (MR) required by the thickness design according to said design procedure, fatigue analysis of pavement is carried out with consecutive use of few 90-day values of modulus of rupture of concrete (MR) considered corresponding to the one value of 28-day specified compressive strength of this concrete f_{c}′, the least of these few values just corresponding to this value of 28-day specified compressive strength is the value of modulus of rupture (MR) required by thickness design of this pavement according to said design procedure, any of these few values of modulus of rupture of concrete (MR) can be used for fatigue analysis of pavement if strength safety of this pavement designed with the use of the certain value of safety factor and this value of modulus of rupture corresponds to the preset strength safety of pavement.

4. Airport concrete pavement of claim 3 of noncritical areas with the thickness determined by results of fatigue analysis, fatigue analysis of pavement fatigue analysis of pavement regardless of forecast of traffic loads and volumes expected during the pavement's design life should be carried out according to the most detailed version of the current Portland Cement Association design procedure or with the use of other methods of fatigue analysis according to the requirements of the customer with more complete utilization of flexural strength of concrete considered as a random value than that provided by the current Portland Cement Association design practice of utilization of this strength by the consecutive use of three values of 90-day modulus of rupture of concrete (MR) with the difference of 50 psi, the least of these three values of modulus of rupture considered as specified flexural strength of concrete is the value of modulus of rupture (MR) required by thickness design of this pavement according to the current Portland Cement Association thickness design procedure, any of these three value of modulus of rupture of concrete (MR) can be used for fatigue analysis of claimed pavement if estimation of strength safety of this pavement designed with the use of the certain value of safety factor and this value of modulus of rupture corresponds to the value of strength safety index β equal at least to about 2.5, sufficiency of thickness of pavement determined regardless of fatigue effect with the use of the values of safety factor the range from 1.5 to 1.7 with more complete utilization of flexural strength of concrete considered as a random value than that provided by the current Portland Cement Association design practice of utilization of this strength should be checked by results of fatigue analysis of this pavement.

5. Existing airport concrete pavement with the estimation of capacity provided according to the current Portland Cement Association design practice of utilization of flexural strength of concrete, more complete utilization of flexural strength of concrete considered as a random value expressed by the use of values of modulus of rupture exceeding the mean value of flexural strength for fatigue analysis of pavement means the revaluation of estimations of strength safety and fatigue strength of this pavement with the corresponding increase of allowable aircraft loads, fatigue analysis of pavement should be carried out according to the most detailed version of the current Portland Cement Association design procedure or with the use of other methods of fatigue analysis according to the requirements of the customer with the consecutive use of three values of modulus of rupture of concrete (MR) with the difference of 50 psi, the least of these three values of modulus of rupture of concrete is the value of modulus of rupture (MR) corresponding to the mean value of flexural strength of concrete, any of these three value of modulus of rupture of concrete (MR) can be used for fatigue analysis of this pavement if estimation of strength safety of this pavement designed with the use of the certain value of safety factor and this value of modulus of rupture corresponds to preset strength safety level of this pavement.
